(19) United States
(12) Patent Application Publication
(10) Pub. No.: US 2020/0036621 A1
(43) Pub. Date: Jan. 30, 2020

(54) WEBSITE LOAD TEST CONTROLS

(71) Applicant: Target Brands, Inc., Minneapolis, MN (US)

(72) Inventors: Narasimhan Veeraraghavan, Maple Grove, MN (US); James Michael Sauber, Lakeville, MN (US)

(21) Appl. No.: 16/518,287

(22) Filed: Jul. 22, 2019

Related U.S. Application Data
(60) Provisional application No. 62/702,608, filed on Jul. 24, 2018.

(51) Int. Cl. H04L 12/26; G06F 9/455

(52) U.S. Cl. CPC H04L 43/50; G06F 2009/45575; G06F 9/45558

(57) ABSTRACT

A method includes receiving an indication of how test data is to be divided between a number of load engines and assigning a portion of the test data to each load engine based on the indication. The load engines are then executed such that each load engine uses its respective portion of the test data to load test at least one website.

### CROSS-REFERENCE TO RELATED APPLICATION

The present application is based on and claims the benefit of U.S. provisional patent application Ser. No. 62/702,608, filed Jul. 24, 2018, the content of which is hereby incorporated by reference in its entirety.

### BACKGROUND

Webservers host websites by receiving requests for pages on the websites and processing those requests to return the content of the webpages. At times, the webservers can receive a large number of requests for webpages. To ensure that a webserver can withstand large amounts of such traffic, load testing is performed on the webserver by having test servers emulate a large number of users and make requests of the webserver for various webpages. The behavior of the webserver is then observed to determine if the webserver becomes overwhelmed or if the webserver begins to return errors.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes receiving an indication of how test data is to be divided between a number of load engines and assigning a portion of the test data to each load engine based on the indication. The load engines are then executed such that each load engine uses its respective portion of the test data to load test at least one website.

In accordance with a further embodiment, a server includes a configuration manager and a test controller. The configuration manager receives a number of load engines to instantiate for a load test, and an indication of how data for the load test is to be divided among the load engines during the load test. The test controller receives an instruction to start the load test and instantiates the number of load engines such that each load engine uses a portion of the data as determined from the indication of how the data is to be divided among the load engines.

In accordance with a still further embodiment, a method includes instructing a server cluster to instantiate a number of load engines to execute a test script to load test a website. A user input is received indicating that the number of load engines should be changed and in response an instruction is sent to the server cluster while the load engines are executing to change the number of load engines that are executing the test script.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for configuring and running load tests in accordance with one embodiment.

FIG. 2 is an example user interface for selecting a path for a load test.

FIG. 3 is a user interface for selecting scripts of a load test in accordance with one embodiment.

FIG. 4 is an example user interface for adding server clusters to scripts in accordance with one embodiment.

FIG. 5 is an example user interface for selecting how data is to be split in accordance with one embodiment.

FIG. 6 is an example user interface showing a defined load test and controls for starting the load test in accordance with one embodiment.

FIG. 7 is a flow diagram for performing a load test in accordance with one embodiment.

FIG. 8 is a flow diagram of a method for dividing data across an entire test.

FIG. 9 is a flow diagram of a method for dividing data across a script of a test.

FIG. 10 is a flow diagram of a method for dividing data across server clusters of a test.

FIG. 11 is an example user interface showing the monitoring of a test in progress.

FIG. 12 is a flow diagram of a method of changing the number of engines in a currently running load test.

FIG. 13 is a user interface for selecting a past period to review webserver performance.

FIG. 14 is a user interface showing webserver performance over a past period.

FIG. 15 is a user interface showing past performance of a webserver for a collection of past requests.

FIG. 16 is an example of a run details user interface showing metrics for a load test run.

FIG. 17 is an example of a run details user interface showing trend charts for a load test run.

FIG. 18 is an example of a run details user interface showing a test history of a load test.

FIG. 19 is an example of a run details user interface showing a comparative charts display.

FIG. 20 is an example of a user interface showing a list of currently running load tests.

FIG. 21 is an example of a user interface showing a list of currently running load tests with a list of locations and load engines for one of the running load tests.

FIG. 22 is a block diagram of a computing environment used in accordance with the various embodiments.

### DETAILED DESCRIPTION

Embodiments described below provide a load test configuration manager and a load test monitor that provide more control over load tests and thereby improve the technology of webserver load testing. In particular, embodiments described below give a user the ability to define how script data is to be divided among load engines assigned to perform the load test. In addition, embodiments allow the user to alter the number of load engines that are instantiated for a load test while the load test is in progress. This provides dynamic control of the load test to the user thereby giving the user better control of the load test.

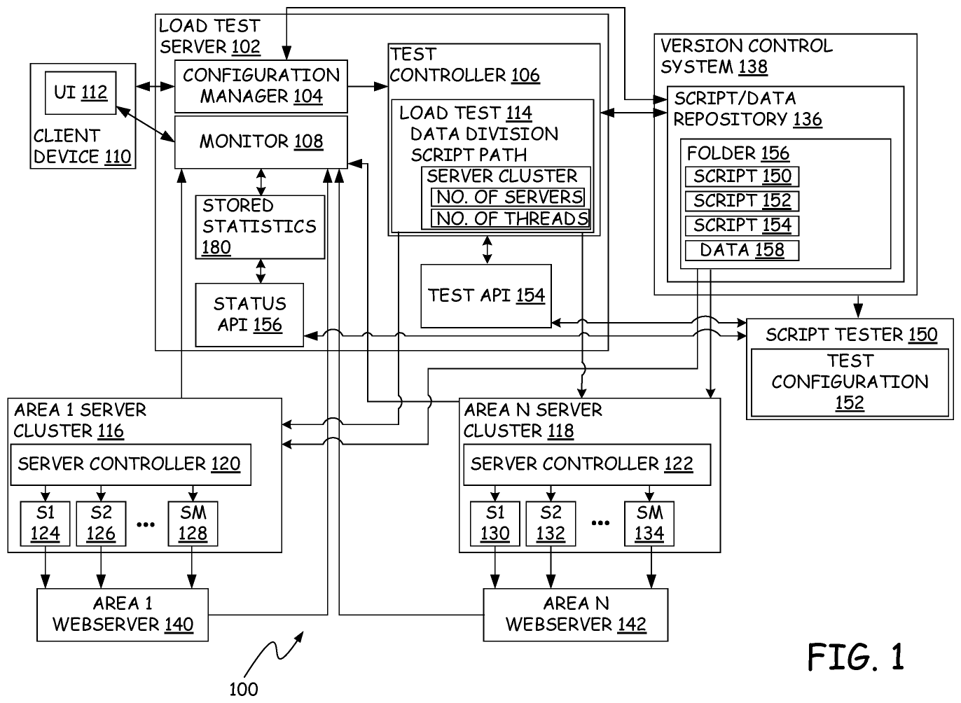

FIG. 1 provides a block diagram of a system 100 for configuring and monitoring load tests of webservers. System 100 includes a load test server 102 having a configuration manager 104, a test controller 106 and a monitor 108. A user of a client device 110 can interact with configuration manager 104 and monitor 108 through user interfaces 112 provided by configuration manager 104 and monitor 108 or through one or more Application Programming Interfaces (not shown). Test controller 106 uses parameters set for one or more load tests, such as load test parameters 114, to instantiate load engines (also referred to as load generators) on one or more servers in each of one or more server clusters, such as area 1 server cluster 116 and area N server cluster 118. In particular, test controller 106 instructs a respective server controller, such as server controllers 120 and 122 for server clusters 116 and 118 to start virtual servers, such as virtual servers 124, 126 and 128 and virtual servers 130, 132 and 134 and once the virtual servers have been started to instantiate load engines on each of the virtual servers. Each load engine executes a script from a script/data repository 136 in a version control system 138. Each script includes one or more requests that the load engine is to make of a respective webserver, such as area 1 webserver 140 and area N webserver 142. In accordance with one embodiment, area 1 webserver 140 and area N webserver 142 have the same domain name and serve the same website but service requests from different geographic locations. In accordance with one embodiment, the server clusters and the number of load engines to be instantiated in each server cluster are designated on a script-by-script basis.

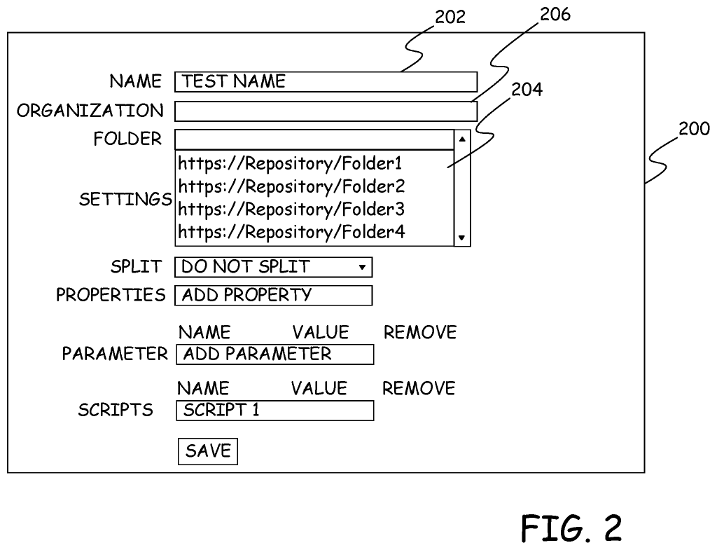

FIG. 2 provides an example user interface 200 produced by configuration manager 104 for configuring a new load test. In user interface 200, a name for the load test is provided in field 202 and a path to a folder containing the scripts to be executed as part of the load test is in the process of being selected from a menu 204. Once selected, the path will appear in folder field 206. In accordance with one embodiment, the path is directed to a script repository 136 maintained in a version control system 138. In accordance with one embodiment, each folder contains a plurality of scripts, such as scripts 150, 152 and 154 in folder 156 of FIG. 1. In addition, each folder includes a data file or data folder, such as data file 158 of FIG. 1. In accordance with one embodiment, data file 158 contains comma separated values representing values for variables found in one or more of the scripts 150, 152 and 154. In accordance with one embodiment, version control system 138 is used to make changes to the various scripts and data files so as to permit various programmers to submit proposed changes to the scripts and data while allowing an owner of the folder to control what changes are accepted. In addition, the version control system allows for scripts to be rolled back to previous versions when the scripts are found to contain errors.

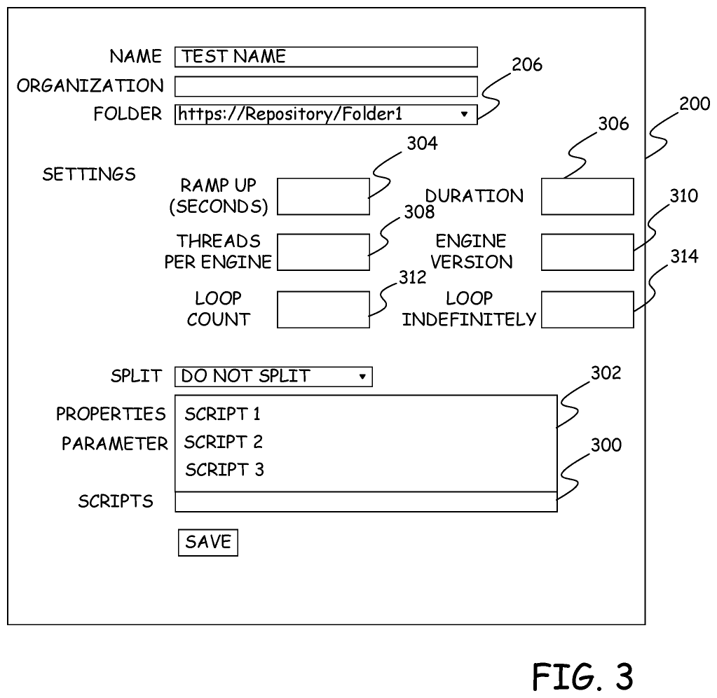

After selecting the folder, one or more scripts can be selected using a script field 300 of FIG. 3, which provides a menu 302 based on the scripts present in the folder selected in field 206. More than one script may be selected from menu 302. User interface 200 also allows various settings for the load test to be set. These include a ramp up time 304, which specifies a period of time over which the load engines are to be brought on-line; a minimum duration 306, which indicates the minimum period of time over which the load test should take place; threads per engine 308, which indicates a minimum number of threads that are to be executed by each engine; engine version 310, which indicates the version of the load engine to be used; loop count 312, which indicates the number of times that each script is to be executed; and loop indefinitely checkbox 314, which indicates that the scripts should loop continuously until duration 306 is reached.

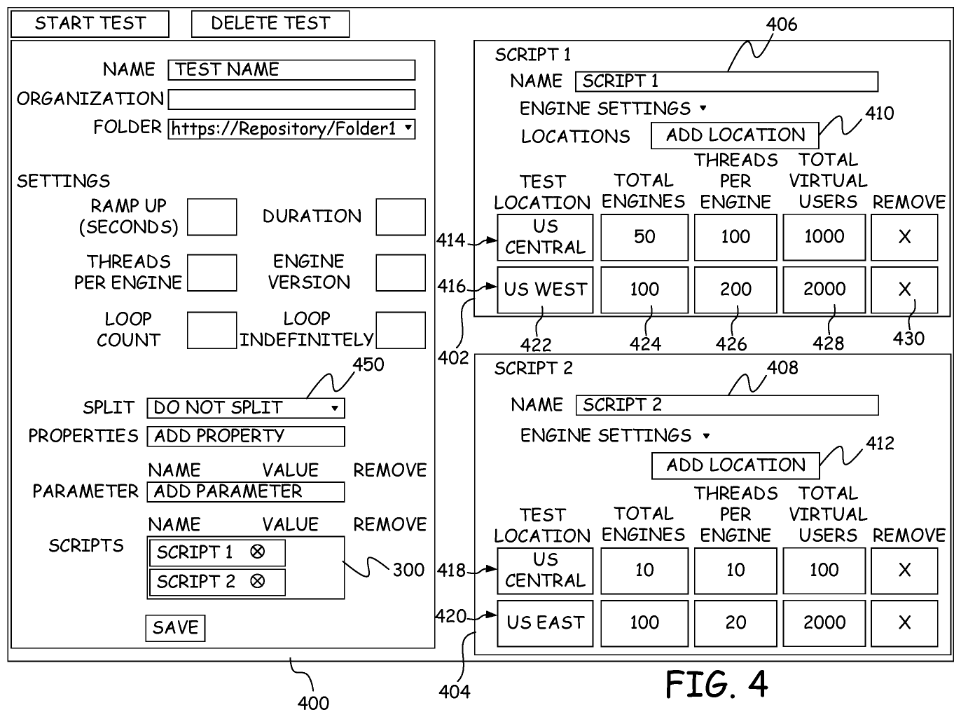

As shown in user interface 400 of FIG. 4, each time a script is selected, a script configuration area is created, such as configuration areas 402 and 404 for the selection of script 1 and script 2 in script field 300. Each script configuration area includes a name field, such as name fields 406 and 408 and an add server cluster control, such as add server cluster controls 410 and 412. Since many users think of the server clusters in terms of the locations were the server clusters are found, the several embodiments shown in the Figures use the word “location” in place of the phrase “server cluster.” Thus, add server cluster controls 410 and 412 have the legend “Add Location” instead of “Add Server Cluster”, and the heading “Test Location” is used in place of “Test Server Cluster.” However, it is to be understood that the references to locations are actually references to server clusters that are situated in those locations.

Each time an add server cluster control is selected, a server cluster row is added, such as server cluster rows 414, 416, 418 and 420. Each row contains a cluster identifier, which is described as a test location in FIG. 4, such as test location 422 for server cluster row 416. This cluster identifier identifies which of the clusters, such as server cluster 116 and 118 of FIG. 1, are to be used to execute the script. Each server cluster row also includes a total number of engines field 424 that indicates the number of load engines that will execute the script, a threads per engine field 426, which indicates the number of separate threads that each engine should start with each thread representing a separate virtual user and a resulting total number of virtual users field 428, which is equal to the total number of engines 424 times the number of threads per engine 426. Each server cluster row also includes a remove control 430 that causes the server cluster row to be removed when selected.

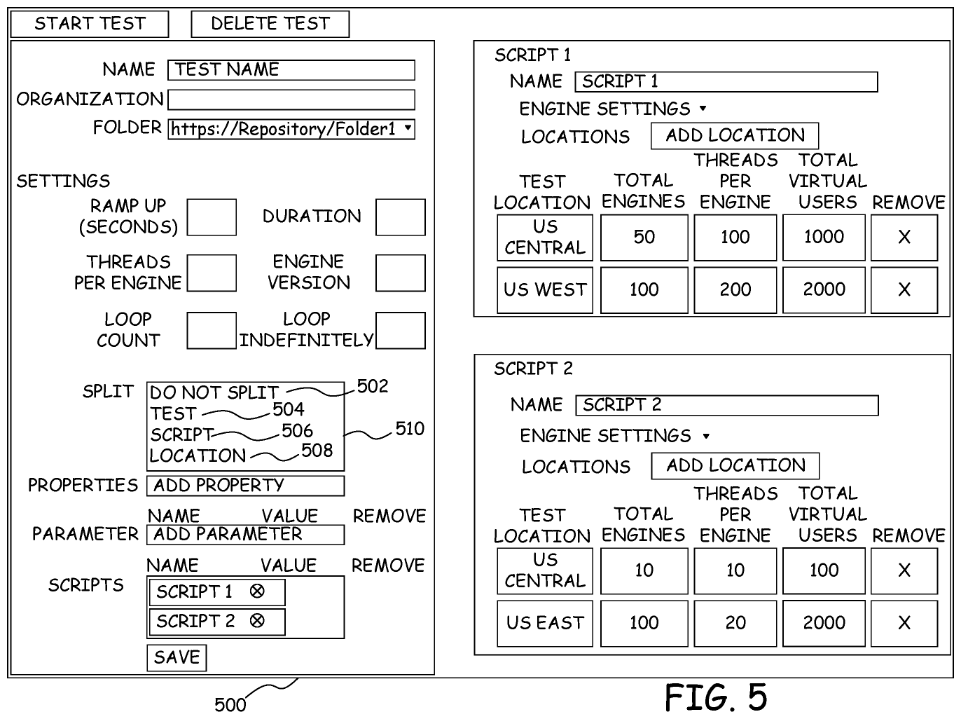

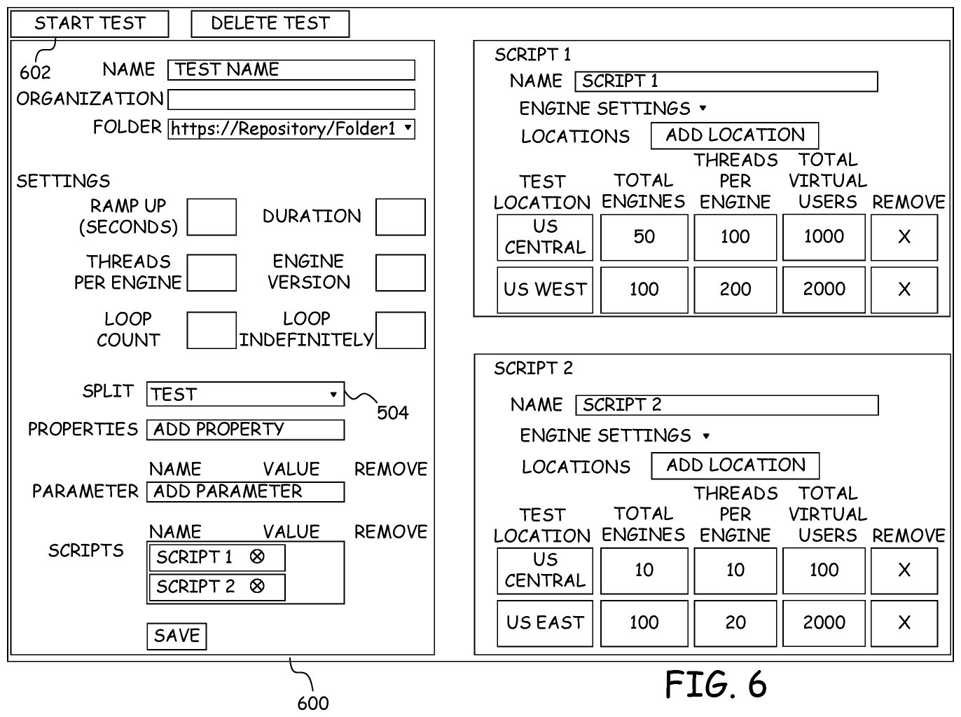

In user interface 400, a split control 450 is used to designate how data file 158 is to be split among the load engines. FIG. 5 provides an example user interface 500 in which split control 450 has been selected to provide a menu of split options 510 including DO NOT SPLIT 502, TEST 504, SCRIPT 506 and LOCATION 508. When DO NOT SPLIT 502 is used, each load engine in each server cluster in each script receives the entire data file 158. When TEST 504 is selected, data file 158 is divided evenly between each load engine in each server cluster in each script. When SCRIPT 506 is selected, a separate copy of data file 158 is designated for each script in the load test and each copy is divided between each load engine in each server cluster assigned to execute the script. When LOCATION 508 is selected, a separate copy of data file 158 is designated for each cluster location of each script and each copy is divided between the load engines in each server cluster that will execute the script. FIG. 6 of user interface 600 shows the selection of TEST control 504 as the basis for splitting the data.

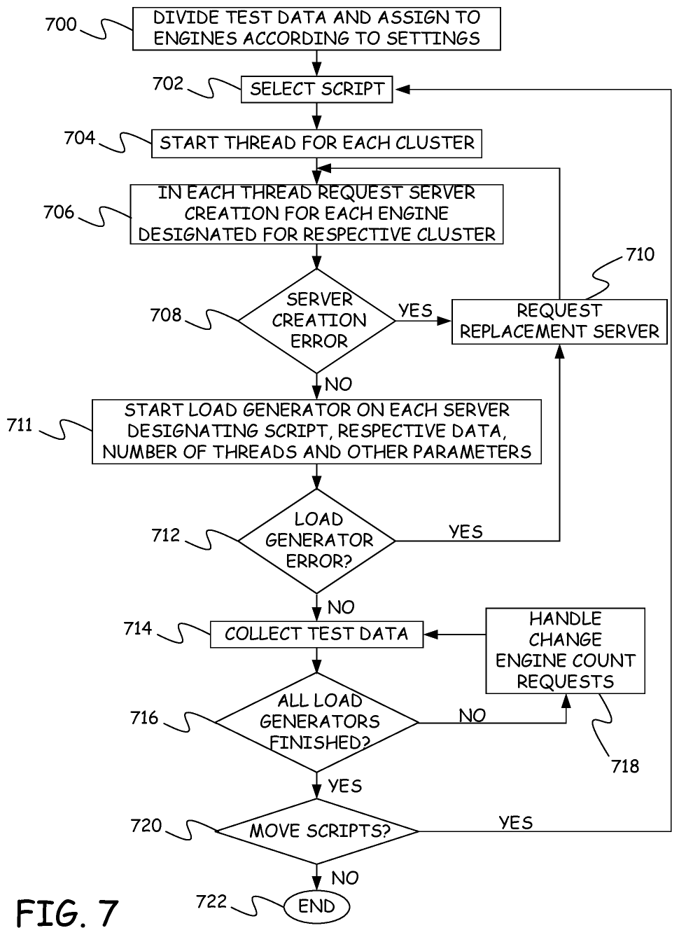

FIG. 6 also includes a “START TEST” control 602 that when selected causes the load test defined in user interface 600 to be executed. FIG. 7 provides a flow diagram of a method of executing a load test that has been configured using configuration manager 104. In step 700 of FIG. 7, the test data is divided and assigned to the engines that will be performing the test according to the configuration settings set in split control 450.

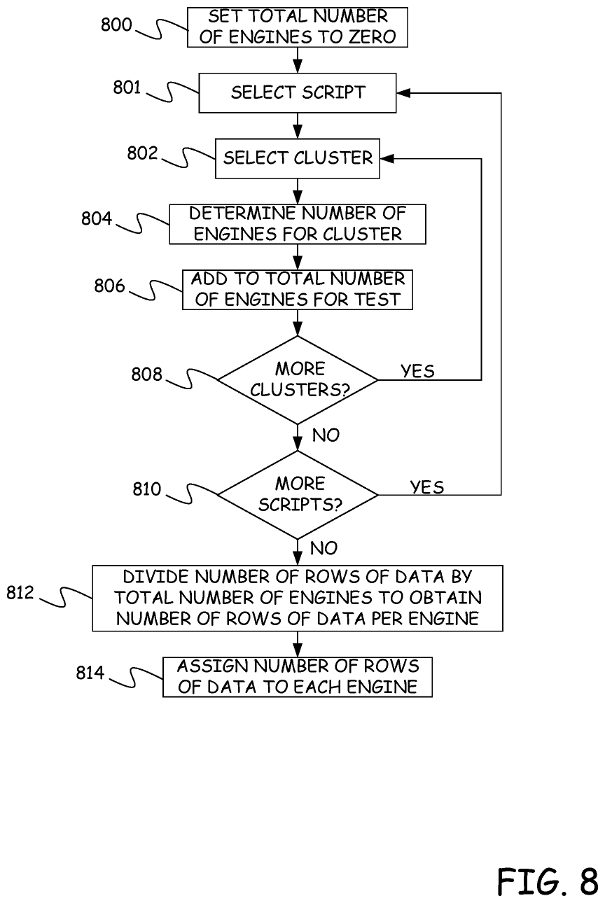

FIG. 8 provides a flow diagram of a method for dividing the data when TEST 504 is selected. In step 800, a total number of engines that are to be used to execute the load test is set to zero. At step 801, a script in load test attributes 114 of the load test is selected and at step 802, a server cluster/location assigned to execute the script is selected. At step 804, the number of engines that are to be instantiated for the selected cluster and script is determined from load test attributes 114. This number is added to the total number of engines that are to be used to execute the load test at step 806. At step 808, the method determines if there are more server clusters/locations that are to execute the currently selected script. If there are more server clusters/locations, the process returns to step 802 to select a new server cluster/location. Steps 804 through 808 are then repeated. When all of the server clusters/locations that are to execute the currently selected script have been processed at step 808, the method determines if there are more scripts that will be executed for the load test. If there are more scripts, the process returns to step 801 to select the next script in the load test. Steps 802-810 are then repeated. When all the scripts have been processed at step 810, the number of rows of data in data file 158 are divided by the total number of engines for the load test to obtain the number of rows of data to be assigned to each engine at step 812. At step 814, each engine in each server cluster for each script is assigned this number of rows of data, where each engine receives different rows of data from every other engine used in the load test.

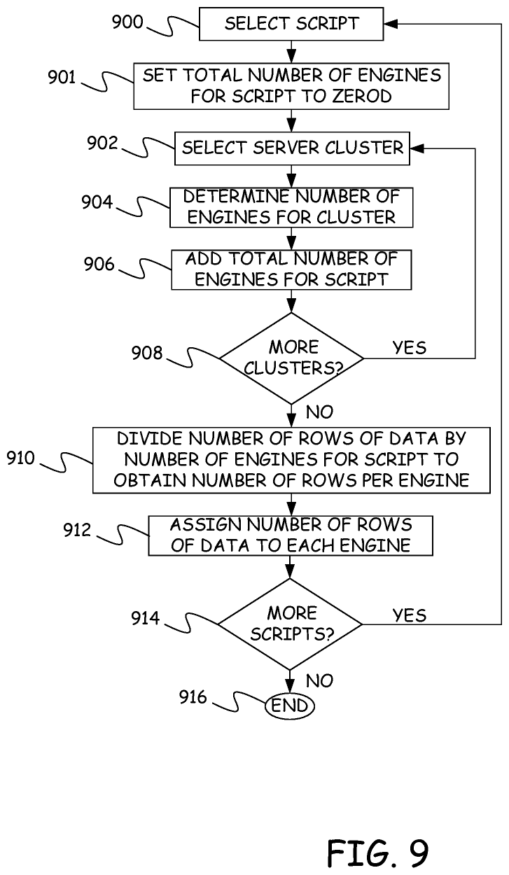

FIG. 9 provides a flow diagram of a method of dividing data on a script basis when SCRIPT 506 of FIG. 5 is selected. At step 900, a script in the load test is selected from load test attributes 114. The total number of engines for the script is set to zero at step 901. A server cluster assigned to the script is then selected at step 902. At step 904, the number of engines designated for the selected cluster is determined from test attributes 114. The number of servers determined at step 904 is added to the total number of servers for the script at step 906. At step 908, the method determines if there are more server clusters assigned to the current script. If there are more clusters, the next server cluster is selected by returning to step 902 and steps 904 through 908 are repeated. When there are no more server clusters assigned to the current script, the number of rows of data in data file 158 is divided by the total number of engines determined for the script to obtain the number of rows per engine at step 910. At step 912, the rows of data in data file 158 are divided between each engine assigned to the script by assigning the determined number of rows of data to each engine. At step 914, the method determines if there are more scripts in the test. If there are more scripts, the next script is selected at step 900 and steps 901 through 912 are repeated. When there are no more scripts, the process ends at step 916. Thus, data file 158 is processed in its entirety by each script with the rows of the data being divided between the engine assigned to execute the script.

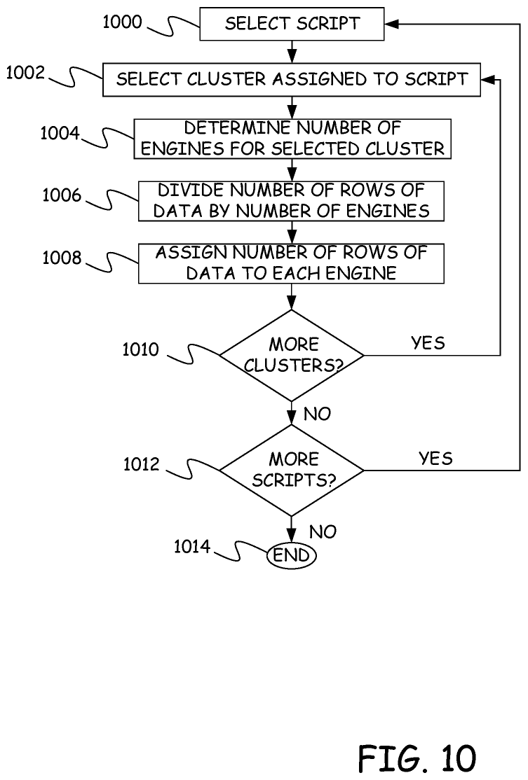

FIG. 10 provides a flow diagram of a method of dividing data file 158 on a server cluster by server cluster basis when LOCATION 508 is selected. At step 1000 of FIG. 10, a script in the load test is selected and at step 1002, a server cluster assigned to execute the script is selected. At step 1004, the number of engines that are to be instantiated for the selected cluster and script is determine from load test attributes 114. The number of rows of data in data file 158 is then divided by the number of engines in the selected cluster at step 1006. Data file 158 is then divided between the engines of the selected cluster by assigning the determined number of rows of data to each engine of the selected cluster at step 1008. At step 1010, the method determines if there are more server clusters for the current script. If there are more server clusters, the process returns to step 1002 and steps 1004, 1006 and 1008 are repeated for the newly selected cluster. When all the clusters for the current script have been processed, the method determines if there are more scripts in the load test at step 1012. If there are more scripts, a new script is selected by returning to step 1000 and steps 1002-1012 are repeated for the new script. When all the scripts have been processed at step 1012, the process ends at step 1014. Thus, through the method of FIG. 10, each cluster set for a script receives a separate copy of data 158 and that copy of the data is divided evenly amongst the engines instantiated for that cluster.

Returning to FIG. 7, after the test data has been divided and assigned to the load engines at step 700, the process continues at step 702 where a script is selected from the load test attributes 114. At step 704, test controller 106 starts a thread for each server cluster defined for the selected script in load test attributes 114. At step 706, in each thread, a series of requests are made to start a virtual server for each engine designated for the respective server cluster. At step 708, if there is an error when starting a virtual server, a replacement server is requested at step 710. If the virtual server is created successfully, a load generator application is started on the virtual server designating the selected script, the respective rows determined in step 700 for this particular load generator, the number of threads that the load generator should create and other parameters that the load generator should use during its execution. At step 712, test controller 106 determines if the load generator has started successfully. If there has been an error during the start of the load generator, the process returns to step 710 to request a replacement server. Thus, the current server is killed at step 710 and a new server is started in the server cluster. If the load generator starts without error, test data begins to be collected as the load generator executes the script at step 714. Periodically, test controller 106 determines if all of the load generators in all of the clusters have finished. If at last one load generator continues to execute the script, test controller 106 handles any change engine count requests 718 for changing the number of load engines operating on one or more the server clusters. After the change in engine count requests have been processed, if any, the process returns to step 714 to continue collecting test data. When all the load generators have finished executing the script at step 716, the test controller 106 determines if there are more scripts to execute for the load test at step 720. If there are more scripts, the process returns to step 702 to select a new script and steps 704-720 are repeated for the new script. When all the scripts of the load test have been executed, the method of FIG. 7 ends at step 722.

During execution of a load test, monitor 108 receives data related to the load test from the servers in each server cluster involved in the test, such as server clusters 116 and 118, and from the webservers being tested such as webserver 140 and webserver 142. This data includes the number of errors received by load engines, the response times for requests made by the load engines, the number of bytes of data sent to and received from the webservers, the number of virtual users being serviced and the number of load engines that are operating. In accordance with one embodiment, the data is collected periodically and provides values for the period of time since data was last sent to monitor 108. For example, each data packet indicates the number of errors that occurred since the last data packet was sent.

Monitor 108 stores the received data in stored statistics 180. In accordance with one embodiment, a separate file is stored for each run of a load test such that the statistics for any previous run can be retrieved. In addition, monitor 108 can access the received data for a currently running load test either by reading the data from a long-term storage device or from random-access memory. As such, monitor 108 can be used to monitor the execution of a load test in real time.

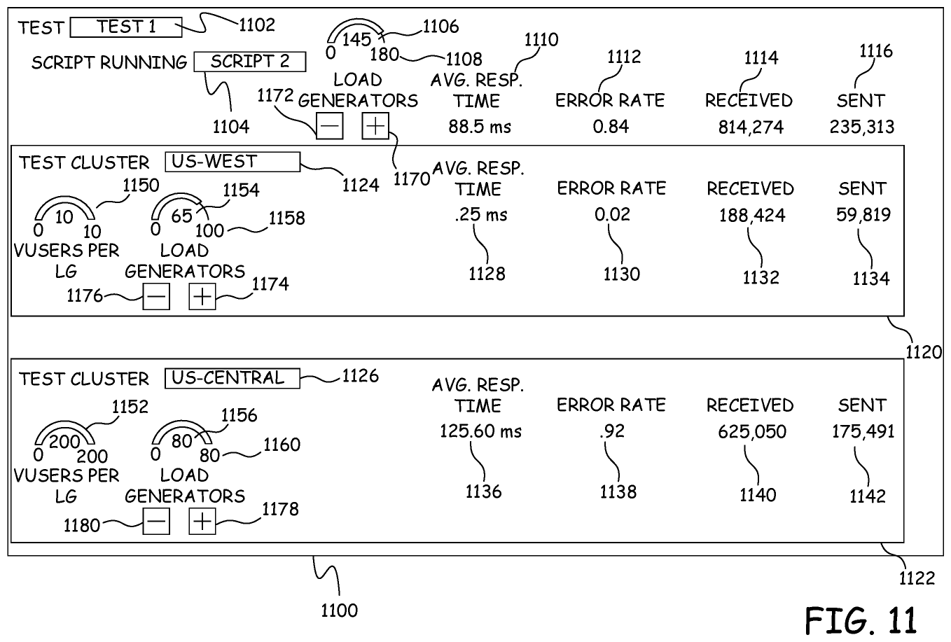

FIG. 11 provides a user interface 1100 generated by monitor 108 to monitor a load test designated as test 1 in field 1102. User interface 1100 identifies the currently running script in a field 1104 as well as the total number of engines currently running the script in field 1106 and the total number of engines designated to run the script in field 1108. User interface 1100 also includes statistics for the script including the average response time for responding to requests in the script in field 1110, the error rate associated with processing requests in field 1112, the number of bytes of data received by the webserver in field 1114 and the number of bytes of data sent by the webserver in field 1116. The summary data at the top of user interface 1100 is broken down by server cluster with respective server cluster display areas 1120 and 1122 for respective server clusters. The identity of each server cluster is found in a respective cluster identifier, such as cluster identifier 1124 and cluster identifier 1126. The statistics for the engines running in each respective cluster are the same as statistics 1110, 1112, 1114 and 1116, except broken down for the engines of the respective clusters. Thus the average response time 1128, error rate 1130, the number of received bytes 1132 and the number of sent bytes 1134 are provided for cluster 1124 and the average response time 1136, error rate 1138, number of received bytes 1140 and number of sent bytes 1142 are provided for the load engines in cluster 1126. Server cluster areas 1120 and 1122 include a number of virtual users per load generator 1150 and 1152, which indicate how many threads or virtual users have been created for each load engine. Areas 1120 and 1122 also indicate the number of load engines or load generators that have been instantiated through designation 1154 and 1156, as well as the number of load engines/load generators assigned to the cluster shown by designations 1158 and 1160, respectively.

User interface 1100 also includes controls for changing the number of load generators/load engines executing script 1104. In particular, user interface 1100 includes an add load generator control 1170 and a remove load generator control 1172 that can be used to add or remove a load generator from each server cluster executing script 1104. Thus, if add load generator control 1170 is selected, an additional load generator will be added to server cluster 1124 and an additional load generator will be added to server cluster 1126. Similarly, if remove load generator control 1172 is selected, one of the currently running load generators on server cluster 1124 is shut down and one of the currently running load generators on server cluster 1126 is shut down. In addition, controls are provided for adding and removing load generators from each cluster individually. For example, add load generator control 1174 will add a load generator to cluster 1124 and remove load generator control 1176 will remove a currently running load generator from cluster 1124. Similarly, add load generator control 1178 will add a load generator to cluster 1126 while remove load generator control 1180 will remove the load generator from cluster 1126. Thus, controls 1170, 1172, 1174, 1176, 1178 and 1180 allow load generators/load engines to be added or removed from the load test while the load test is taking place. This gives the user of client device 110 more control over the test by allowing the user to increase the loads against the webserver dynamically while the test is taking place or reduce the load against the webserver while the test is taking place. The ability to add and remove load engines, particularly on a cluster-by-cluster basis, improves the efficiency of identifying the exact load that begins to cause response times to reach an unacceptable level.

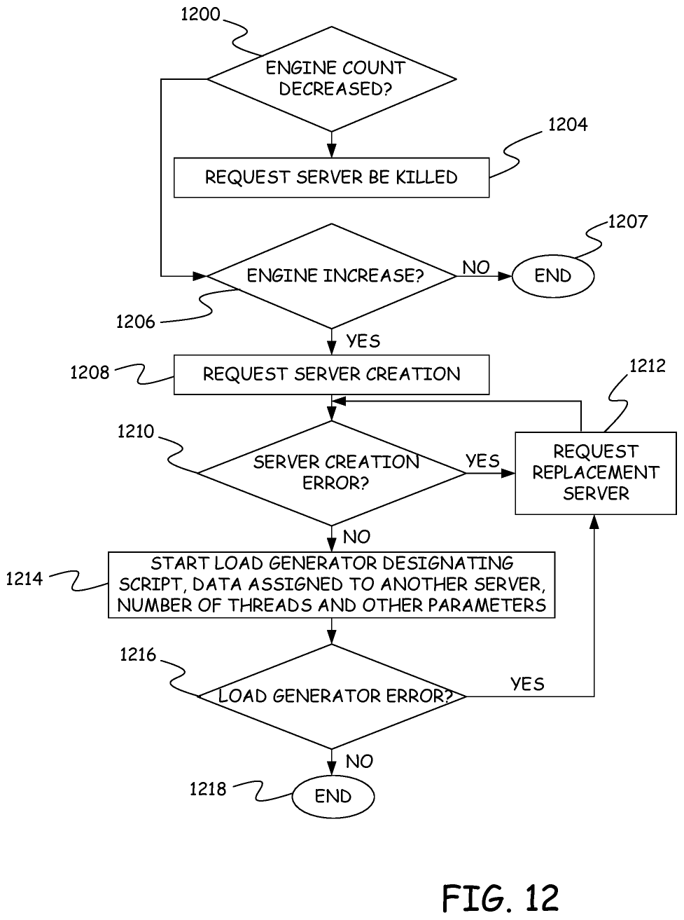

FIG. 12 provides a flow diagram of a method of adding or removing load engines during a load test. In step 1200, the method determines if the engine count is to be decreased. If the engine count is to be decreased, a server that is currently running on the cluster is killed at step 1204. If the engine count is not to be decreased, the method determines if the engine count is to be increased at step 1206. If the engine count is not to be increased, there is no change in the engine count and the process ends at 1207. If the engine count is to be increased at step 1206, test controller 106 requests a virtual server be created on the designated cluster at step 1208. If there is a server creation error at step 1210, a replacement server is requested at step 1212 and the process returns to step 1210 to see if the server creation was successful. If the server was created successfully at step 1210, a load generator is started on the newly created server and the current script is assigned to the load generator together with the data assigned to another server in the cluster at step 1214. The number of threads and other parameters designated for the other load generators in the cluster are assigned to the newly started load generator. At step 1216, the process determines if the load generator started without error. If there was an error, the process returns to step 1212 where the server containing the error is killed and a replacement server is requested. If the load generator started without error at step 1216, the process ends at step 1218.

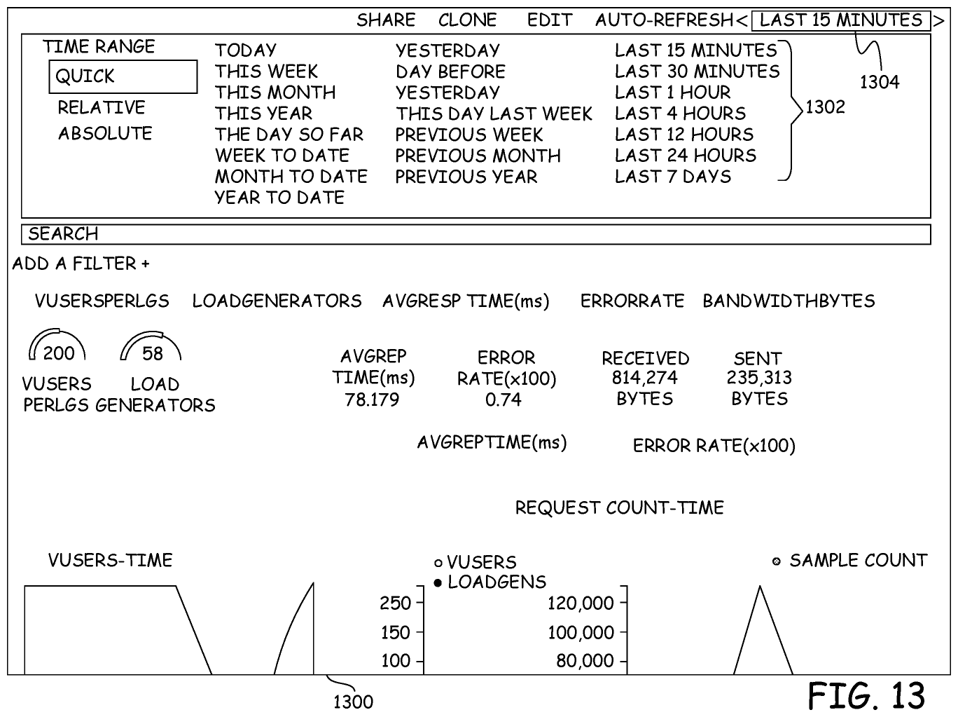

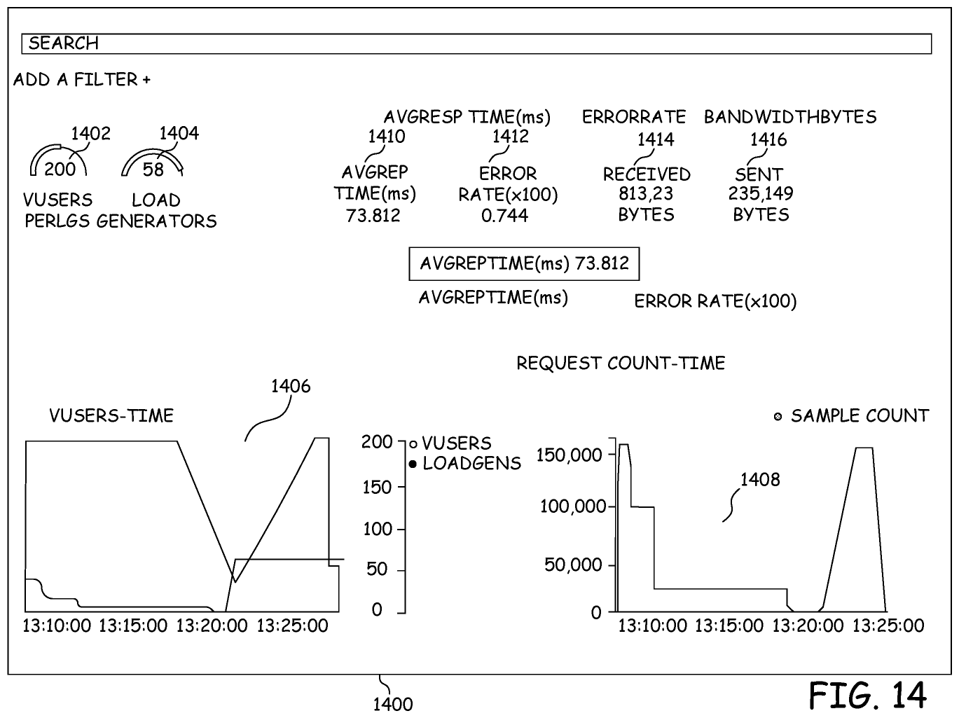

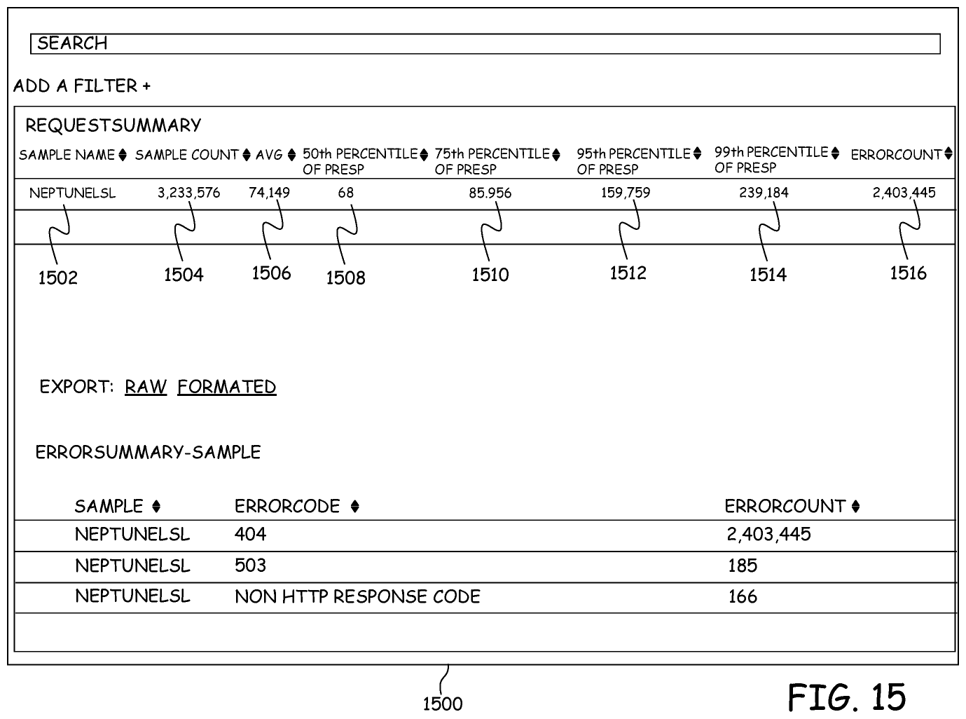

Monitor 108 can also generate user interfaces 112 that allow a summary of the past performance of the webserver to be displayed. FIG. 13 provides an example user interface 1300 showing the selection of a time period over which such a summary is to be determined. In particular, a list of available time ranges 1302 is provided upon selection of a control 1304. Upon selection of one of the time ranges, monitor 108 retrieves stored statistics 180 for the webserver for the selected time range and displays the stored statistics in a user interface, such as user interface 1400 of FIG. 14. In user interface 1400, the current number of virtual users for the current load tests is shown by designation 1402, the current number of load generators for the current load tests is shown by designation 1404, and a histogram 1406 of virtual users as a function of time is shown together with a histogram of request counts as a function of time 1408. The average response time of the webserver over the period is shown in field 1410, the error rate is shown in field 1412, the number of bytes received is shown in field 1414 and the number of bytes sent is shown in field 1416.

Monitor 108 can also provide a user interface 1500 that shows a response time for various percentiles of requests across a sampling of requests. For example, in user interface 1500 a sample 1502 of requests that contains 3,233,576 request as indicated by sample count field 1504 is shown to have an average response time 1506 where the 50^{th} percentile of requests have a response time 1508, the 75^{th} percentile of requests have a response time 1510, the 95^{th} percentile of requests has a response time 1512 and the 99^{th} percentile has a response time 1514. In addition, the number of requests that include an error is shown in field 1516.

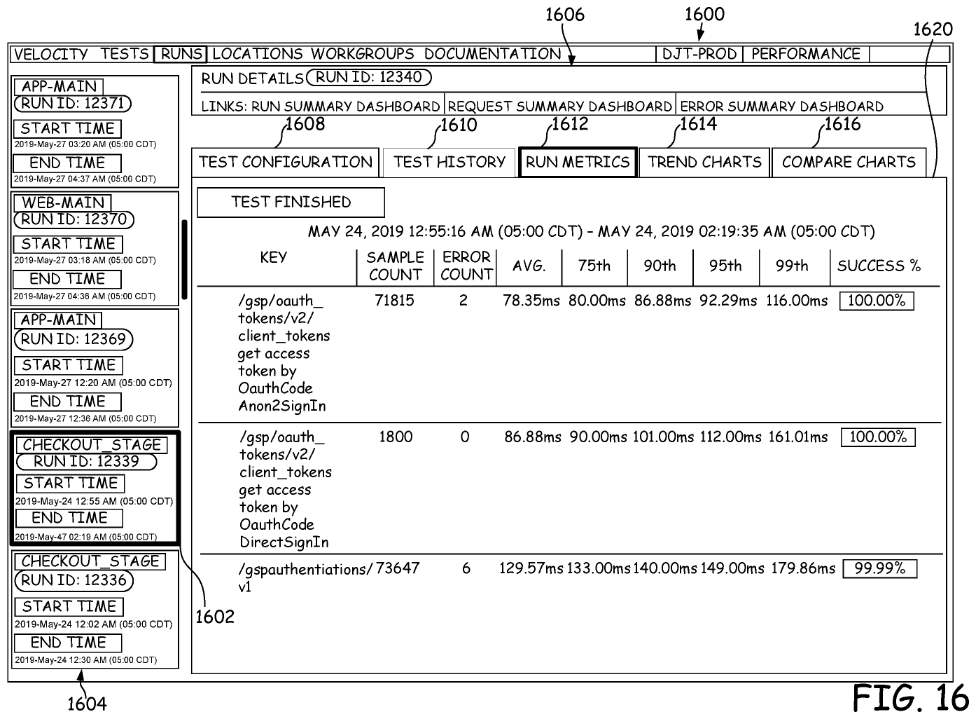

As noted above, stored statistics 180 include statistics for past runs of load tests. Details of a past run of a load test can be viewed by selecting the past run from a menu of recent runs. For example, a recent run 1602 can be selected from a menu of recent runs 1604 displayed on a Runs page 1600 of FIGS. 16-19 to obtain a Run Details frame 1606 that provides details for the selected run.

Run Details frame 1606 includes a test configuration tab 1608, a test history tab 1610, a run metrics tab 1612, a trend charts tab 1614, and a compare charts tab 1616. When test configuration tab 1608 is selected, parameters for the test are displayed including the list of scripts for the test, the locations and number of engines that executed each script, the number of threads per engine and any other configuration parameters of the run of the load test.

When run metrics tab 1612 is selected, run metrics 1620 of FIG. 16 are shown, which include separate metrics for each request page in the scripts of the test. In accordance with one embodiment, the run metrics include the number of times the page was requested, the number of errors that occurred during those page requests, the average response time, and the response times for various percentiles of requests. Note that the percentiles include requests made by different load engines and in some cases different server clusters. For example, the 90^{th} percentile can include requests made by two different server clusters provided by two different cloud providers.

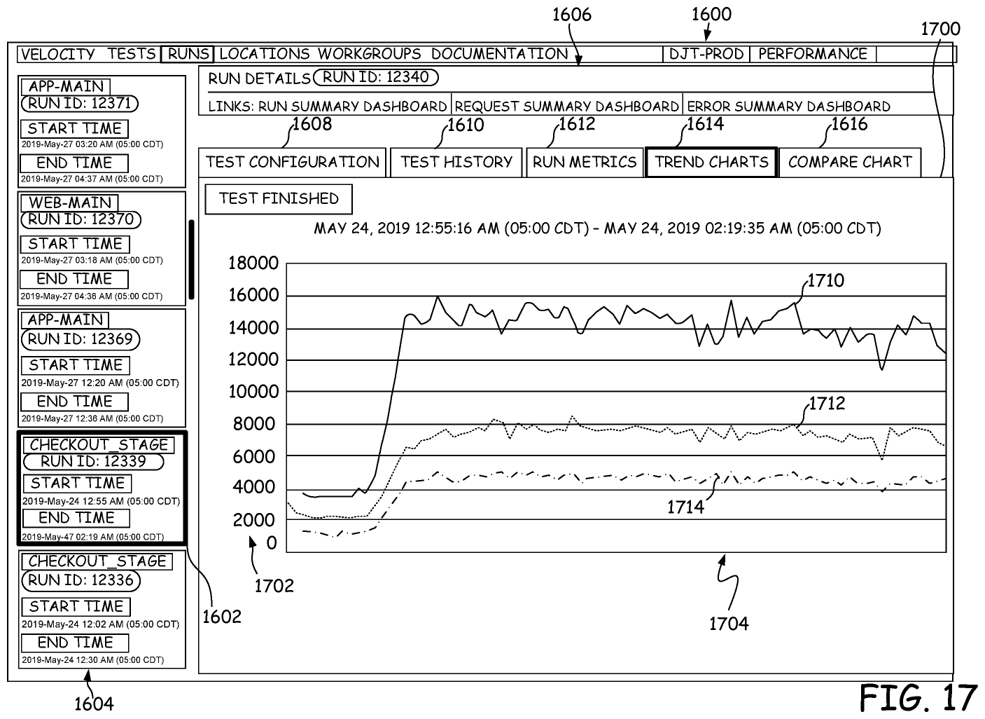

When trend charts tab 1614 is selected, trend charts 1700 of FIG. 17 are shown, which include a separate response time chart for each requested page in the scripts of the test. In the charts, response time is shown along vertical axis 1702 and load test run time is shown along horizontal axis 1704. In the example of FIG. 17, only three graphs 1710, 1712 and 1714 are shown for three respective requested pages.

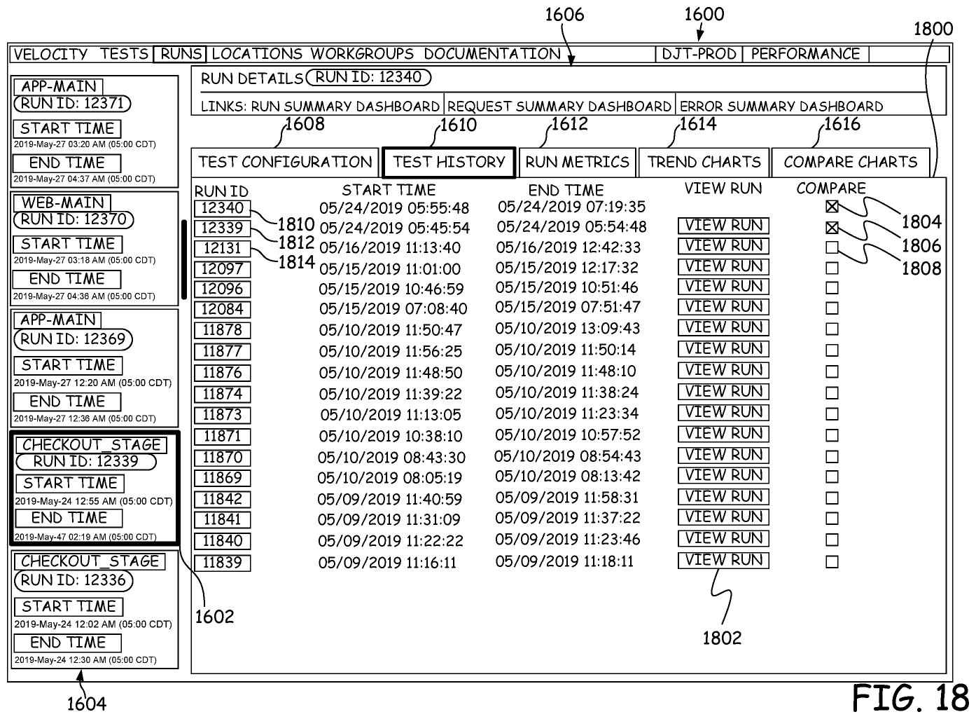

When test history tab 1610 is selected, a history 1800 of FIG. 18 is shown that includes a list of past runs of the load test. Each run in the list includes a View Run button, such as view run button 1802. Selecting the View Run button for a run will provide the Run Detail frame 1606 for the selected run. Each run also includes a Compare checkbox such as checkboxes 1804, 1806, and 1808 for runs 1810, 1812, and 1814. The Compare checkboxes are used to indicate whether a run will be included in comparative charts that can be viewed by selecting compare charts tab 1616. In the example of FIG. 18, Compare checkboxes 1804 and 1806 have been selected but the remaining checkboxes have not been selected. As a result, only graphs for runs 1810 and 1812 will be presented when compare charts tab 1616 is selected.

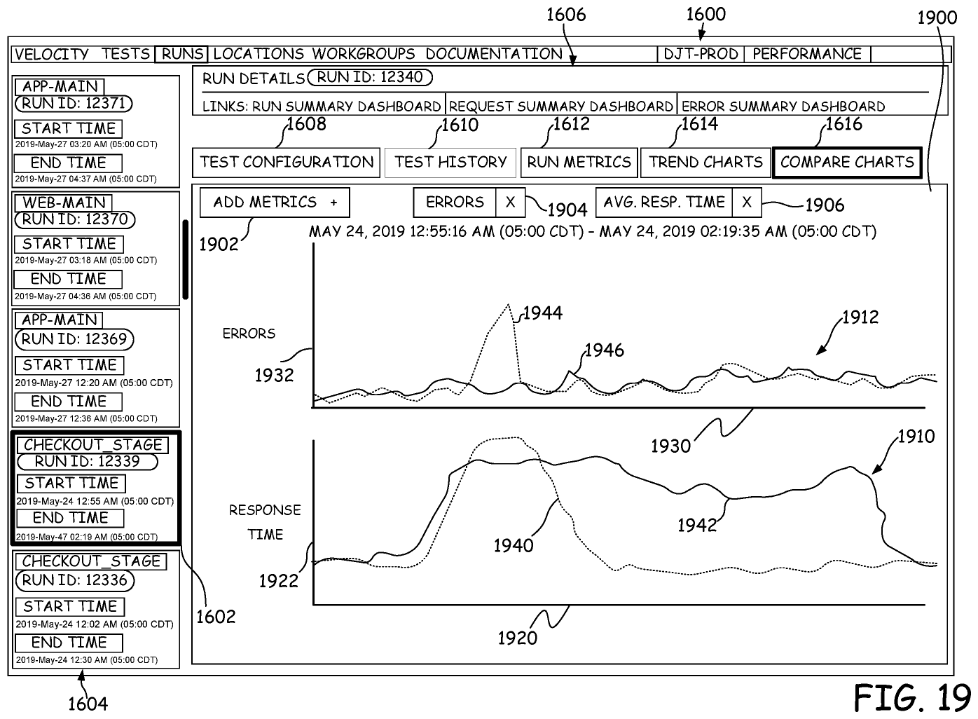

When compare charts tab 1616 is selected, comparative charts display 1900 of FIG. 19 is rendered. Comparative charts display 1900 provides charts of different selected metrics for the runs selected in history 1800. To add a chart for a metric, an Add Metrics control 1902 is used to open a menu of available metrics and one of the available metrics is selected. When a metric is selected, a chart for the selected metric is added to comparative charts display 1900 and a metric box, such as metric boxes 1904 and 1906, having a close control (X) is displayed.

In the example shown in FIG. 19, two metrics have been selected producing response time chart 1910 and errors chart 1912 as well as response time metric box 1906 and errors metric box 1904. Response time chart 1910 includes a horizontal axis 1920 for the elapsed run time of the test and a vertical axis 1922 for the average response time of all page requests made at a particular elapsed run time. Error chart 1912 includes a horizontal axis 1930 for the elapsed run time of the test and a vertical axis 1932 for the average number of errors produced at a particular elapsed run time. Charts 1910 and 1912 include two graphs for two respective runs with chart 1910 having a graph 1940 for a run 1810 of FIG. 18 and a graph 1942 for a run 1812 of FIG. 18 and chart 1912 having a graph 1944 for run 1810 and a graph 1946 for run 1812.

When a close control is selected in a metric box, the metric box and the corresponding chart is removed from comparative charts display 1900. For example, if the close control of errors metric box 1904 were selected, errors metric box 1904 would be removed and chart 1912 would be removed.

In accordance with one embodiment, hovering a pointer over one of the graphs produces a pop-up that identifies the run corresponding to the graph by one or more of the Run Id and/or the start time of the run. In further embodiments, the pop-up includes a control to remove the run from the charts. In other embodiments, an Add Run control is provided on comparative charts display 1900 to allow the addition of more runs without having to return to the test history.

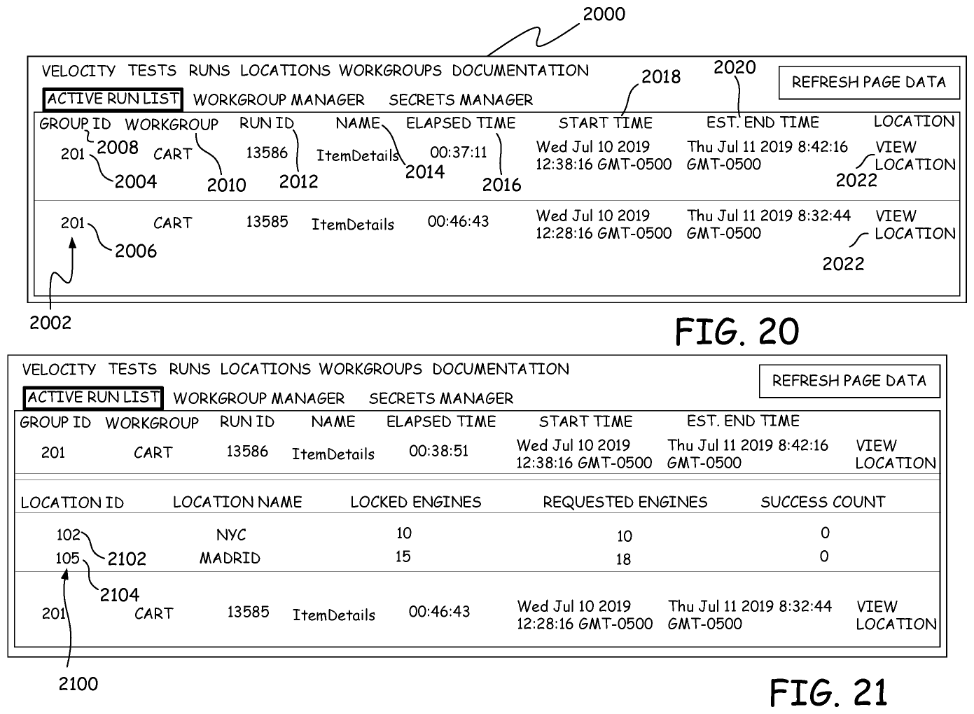

In the example of FIG. 19, the graphs are limited to runs of a single load test. In other embodiments, graphs are provided for runs in other load tests that have been selected using the checkboxes provided for the runs of those load tests. Further embodiments provide administrators with the ability to view all active load tests that are being executed for an enterprise. FIG. 20 provides an example user interface 2000 showing a list 2002 of active load tests that includes load test entry 2004 and load test entry 2006. For each load test, list 2002 provides the workgroup Id 2008, workgroup name 2010, run Id 2012, load test name 2014, elapsed time 2016 since the load test run started, start time 2018 of the load test run, estimated end time 2020 of the load test run, and a view locations control 2022. In accordance with one embodiment, load test script files and data are segregated such that groups of users are only allowed to access the script files and data assigned to their respective group and not the script files and data of other groups. Workgroup Id 2008 and workgroup name 2010 identify the group of users who are responsible for the active load test. Although only a single workgroup is shown in the example of FIG. 20, at other times, list 2002 will include load tests from all workgroups in the enterprise who are currently executing a load test.

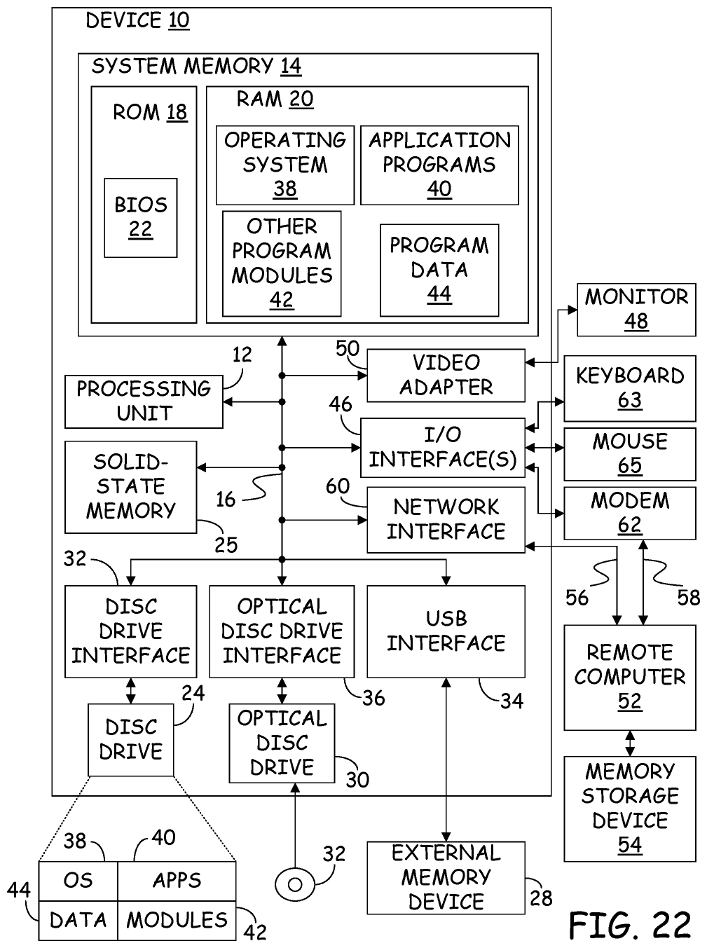

When selected, view locations control 2022 causes a list of locations where the load test is being executed to be displayed below the load test entry. For example, when view locations control 2022 of load test entry 2004 is selected, location list 2100 of FIG. 21 is displayed below load test entry 2004. Location list 2100 includes a separate entry for each location where the test is being executed such as entries 2102 and 2104. Each entry provides a location ID, a location name, a number of load engines that are currently running (locked engines), a number of load engines that were requested (requested engines) and a success count.

Using elapsed time 2016 and the number of load engines that are currently running for a load test, the administrator can identify load tests that have been running for too long or that are using too many load engines and thereby impacting the ability of other load tests to run.

In accordance with a further embodiment, version control system 138 of FIG. 1 allows scripts and data to be tested before being used to apply a load to a webserver. In particular, version control system 138 provides controls for invoking a script tester 150 of FIG. 1 to inspect the script for coding errors and to execute the script to determine how it performs. Script tester 150 executes the script using one or more test configuration values 152 including values for the number of load engines and threads to be invoked. In some embodiments, test configuration values 152 include one or more criteria for determining whether a script passes or fails the performance test. For example, the criteria can indicate that if the average response time ever exceeds a threshold response time or the number of errors ever exceeds a threshold, the script fails the performance test.

Script tester 150 submits the load engine and thread configuration values of the test along with the script(s) for the test through a test API 154 to test controller 106. Test controller 106 uses the configuration values to instantiate load engines (also referred to as load generators) on one or more servers in each of one or more server clusters. In particular, test controller 106 instructs a server controller for a server cluster to start virtual servers and once the virtual servers have been started to instantiate load engines on each of the virtual servers. Each load engine executes the script from script/data repository 136 in version control system 138.

When the load engines begin executing the script, metrics such as errors and response times are provided by the load engines and the webserver to monitor 108, which stores the metrics in stored statistics 180.

A status API 156 is provided to receive and process requests from script tester 150 for the status of the script test. For example, status API 156 supports requests for the execution status of the test (not started, still executing, finished), requests for a summary of performance statistics (average errors, average response time, for example) and requests for pass/fail designations for the test based on the test configuration criteria 152 provided to test API 154.

When status API 156 receives a request for the execution status of a test, status API 156 access stored statistics 180 to see if the test has been started, is currently executing, or has finished executing. Status API 156 then returns the retrieved execution status.

When status API 156 receives a request for summary statistics, status API 156 first determines if the test is finished executing. If the test is not finished, status API 156 returns an error indicating that the test is not finished. If the test is finished, status API 156 retrieves the requested metrics for the test from stored statistics 180 and calculates the stored summary statistics from the retrieved metrics. Status API 156 then returns the requested summary statistics.

When status API 156 receives a request for a pass/fail designation for the test, status API 156 first determines if the test is finished executing. If the test is not finished, status API 156 returns an error indicating that the test is not finished. If the test is finished, status API 156 retrieves the pass/fail criteria for the test by either making a request to test API 154 or by accessing a memory location where test API 154 stored the pass/fail criteria received from script tester 150. Status API 156 then identifies the metrics needed to evaluate the pass/fail criteria and retrieves those metrics from stored statistics 180. Based on the values of the retrieved metrics and the pass/fail criteria, status API 156 then determines whether the script passed the test and returns a pass designation or a fail designation to script tester 150.

Script tester 150 then returns the execution status, the summary statistic, and/or the pass/fail status of the script to a user either directly through a user interface generated by script tester 150 or through a report that is provided to version control system 138.

FIG. 22 provides an example of a computing device 10 that can be used as a server in a server cluster, a webserver, load test server 102 and/or client device 110 in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 22. The network connections depicted in FIG. 22 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/0 interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 22 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
receiving an indication of how test data is to be divided between a number of load engines;
assigning a portion of the test data to each load engine based on the indication; and
executing the load engines such that each load engine uses its respective portion of the test data to load test at least one website.

2. The method of claim 1 further comprising receiving an indication of a plurality of testing scripts to be executed as part of the load test of the at least one website.

3. The method of claim 2 further comprising receiving an indication of server clusters assigned to each script and a number of load engines to be instantiated in each server cluster.

4. The method of claim 3 wherein receiving an indication of how test data is to be divided between load engines comprises receiving an indication that the test data is to be divided between all load engines in all server clusters in all scripts of the load test.

5. The method of claim 3 wherein receiving an indication of how test data is to be divided between load engines comprises receiving an indication that the test data is to be divided between all load engines in all server clusters of each script on a script-by-script basis.

6. The method of claim 3 wherein receiving an indication of how test data is to be divided between load engines comprises receiving an indication that the test data is to be divided between all load engines of each server cluster on a server cluster-by-server cluster basis.

7. The method of claim 1 further comprising while the load engines are executing, receiving an indication that the number of load engines should be changed and in response changing the number of load engines that are executing.

8. A server comprising:
a configuration manager receiving a number of load engines to instantiate for a load test, and an indication of how data for the load test is to be divided among the load engines during the load test; and
a test controller receiving an instruction to start the load test and instantiating the number of load engines such that each load engine uses a portion of the data as determined from the indication of how the data is to be divided among the load engines.

9. The server of claim 8 wherein receiving the number of load engines to instantiate comprises receiving a respective number of load engines to instantiate in each server cluster of a set of server clusters.

10. The server of claim 9 wherein receiving the number of load engines to instantiate in each server cluster comprises receiving a respective number of load engines to instantiate in each server cluster assigned to each script of the load test.

11. The server of claim 10 wherein the indication of how to divide the data indicates that the data is to be divided between all of the load engines in the load test.

12. The server of claim 10 wherein the indication of how to divide the data indicates that the data is to be divided between the load engines instantiated for each script on a script-by-script basis.

13. The server of claim 10 wherein the indication of how to divide the data indicates that the data is to be divided between the load engines instantiated for each server cluster on a server cluster-by-server cluster basis.

14. The server of claim 8 wherein the test controller receives a further instruction while the load engines are executing to instantiate a further load engine and in response, the test controller instantiates a further load engine.

15. The server of claim 10 wherein the test controller receives a further instruction while the load engines are executing to instantiate a further load engine in each server cluster assigned to each script and in response, the test controller instantiates a further load engine in each server cluster assigned to each script.

16. A method comprising:
instructing a server cluster to instantiate a number of load engines to execute a test script to load test a website;
receiving a user input indicating that the number of load engines should be changed; and
sending an instruction to the server cluster while the load engines are executing to change the number of load engines that are executing the test script.

17. The method of claim 16 wherein sending the instruction to the server cluster comprises instructing the server cluster to kill a virtual server on which one of the load engines is executing.

18. The method of claim 16 wherein sending the instruction to the server cluster comprises instructing the server cluster to start a virtual server and to instantiate a load engine on the virtual server to execute the test script.

19. The method of claim 16 wherein receiving the user input comprises receiving the user input relative to the test script.

20. The method of claim 16 wherein receiving the user input comprises receiving the user input relative to a load test and wherein sending an instruction to the server cluster comprises sending an instruction to change the number of load engines to a plurality of server clusters executing a test script of the load test.
